(19) United States
(12) Patent Application Publication
(10) Pub. No.: US 2026/0347136 A1
(43) Pub. Date: Nov. 5, 2026

(54) STACK CLAMPING DEVICE

(71) Applicant: SAMSUNG SDI CO., LTD., Yongin-si (KR)

(72) Inventors: Won Ho SUNG, Yongin-si (KR); Ki Jin SHIN, Yongin-si (KR); Sun Min AHN, Yongin-si (KR); Min Hwi KIM, Yongin-si (KR)

(21) Appl. No.: 19/322,939

(22) Filed: Sep. 9, 2025

(30) Foreign Application Priority Data
May 2, 2025 (KR) 10-2025-0058155

(51) Int. Cl. B65H 31/26; H01M 10/04

(52) U.S. Cl. CPC B65H 31/26; H01M 10/0404

(57) ABSTRACT

An electrode assembly stack clamping device comprises a main body having a polyhedral shape. A connecting portion extends from an end of the main body. A tip extends from an end of the connecting portion. A grip pad is detachably attached to one surface of the tip.

### CROSS-REFERENCE TO RELATED APPLICATION

The present application claims priority to and the benefit of Korean Patent Application No. 10-2025-0058155, filed on May 02, 2025, in the Korean Intellectual Property Office, the entire disclosure of which is incorporated herein by reference

### BACKGROUND

### 1. FIELD

Embodiments of the present disclosure relate to a stack clamping device.

### 2. DESCRIPTION OF THE RELATED ART

A secondary battery generally includes an electrode assembly composed of a positive electrode and a negative electrode, a case accommodating the same, and electrode terminals connected to the electrode assembly.

Electrode assemblies can be formed as a winding type and a stack type according to how the electrode assemblies are structured. When manufacturing a stack-type electrode assembly, electrode plates are supplied one by one on a stack table and stacked together with a separator to create an electrode assembly stack. A clamp is used to fix the electrode assembly stack. The clamp includes a urethane coating portion to prevent damage to the electrode assembly. However, existing clamps are structurally weak with respect to impacts and bend easily. Thus, there is a problem that frequent replacement of a clamp is required. Further, the manufacturing process of the clamp is complicated and thereby expensive.

The information disclosed in this section is provided only for enhancement of understanding of the background of the disclosure and therefore it may contain information that does not constitute related (or the prior) art.

### SUMMARY

Embodiments of the present disclosure provide a stack clamping device having an improved structure.

These and other aspects and features of the present disclosure will be described in or will be apparent from the following description of embodiments of the present disclosure.

A stack clamping device for stacking electrode assemblies according to embodiments of the present disclosure may include a main body having a polyhedral shape; a connecting portion extending from an end of the main body; a tip extending from an end of the connecting portion; and a grip pad detachably attached to a surface of the tip.

The connecting portion may be inclined relative to upper and lower surfaces of the stack clamping device.

The tip may extend along a longitudinal direction of the main body.

The grip pad may be attached to the surface of the tip so as to face the electrode assembly stack in a stacking process.

The stack clamp may further include a concave mounting surface to which the grip pad is attached.

The grip pad may be attached to the mounting surface by an adhesive or an adhesive tape.

The main body, the connecting portion, and the tip may be provided as one body.

The main body, the connecting portion, and the tip may be made of steel.

The grip pad may be a sheet made of a urethane material.

The grip pad may have a thickness that protrudes outwardly from the tip.

In addition, a stack clamping device for stacking electrode assemblies according to embodiments of the present disclosure may include a main body having a side that is trapezoidal shaped; a connecting portion extending from an end of of the main body; a tip extending from an end of the connecting portion; and a grip pad detachably attached to a surface of the tip.

The main body may include a connecting portion which is a side surface vertically connecting the upper surface and a lower surface that are parallel to each other, and an inclined surface connecting the upper surface and the lower surface.

The tip may extend from the connecting portion to form the same plane as the upper surface of the main body.

The surface of the tip may include a concave mounting surface.

The grip pad may be attached to the mounting surface by an adhesive or an adhesive tape.

The grip pad may be a sheet of made of a urethane material.

The grip pad may have a thickness that protrudes outwardly from the tip.

Other than the grip pad, the stack clamp may be made of steel.

According to embodiments of the present disclosure, the structure of a stack clamp is improved so as to not bend easily even when subjected to frequent impacts, thereby extending the stack clamp replacement cycle and reducing the manufacturing cost. In addition, by improving the manufacturing process of the complex grip pad, the manufacturing cost of a clamp is reduced.

However, aspects and features of the present disclosure are not limited to those described above, and other aspects and features not mentioned will be clearly understood by a person skilled in the art from the detailed description, described below.

### BRIEF DESCRIPTION OF THE DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings.

FIG. 1 is a schematic diagram showing parts of a manufacturing device for manufacturing a stack-type electrode assembly.

FIG. 2 is a side view of a clamping device for clamping an electrode assembly stack.

FIG. 3 shows an electrode assembly stack manufactured by the manufacturing device shown in FIGS. 1 and 2.

FIG. 4 is a perspective view of a stack clamp of the clamping device according to FIG. 2.

FIG. 5 is a side view of the stack clamp shown in FIG. 4.

FIG. 6 is a perspective view of a stack clamp according to an embodiment of the present disclosure.

FIG. 7 is a side view of the stack clamp shown in FIG. 6.

FIG. 8 is a side view showing the detailed structure and size of the stack clamp shown in FIG. 6.

### DETAILED DESCRIPTION OF EXEMPLARY EMBODIMENTS

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be further understood that the terms "includes," "including," “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Additionally, in order to facilitate understanding of the invention, the attached drawings are not drawn to scale and the dimensions of some components may be exaggerated. Additionally, the same reference numbers may be assigned to the same components in different embodiments.

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being "linked," "coupled," or "connected" to another component, the elements may be directly “coupled,” “linked” or "connected" to each other, or another component may be "interposed" between the components".

Throughout the specification, when "A and/or B" is stated, it means A, B or A and B, unless otherwise stated. That is, “and/or” includes any or all combinations of a plurality of items enumerated. When "C to D" is stated, it means C or more and D or less, unless otherwise specified.

The terms used in this specification are for describing embodiments of the present disclosure and are not intended to limit the disclosure.

First, with reference to the attached drawings, a clamping device according to a secondary battery manufacturing device will be described.

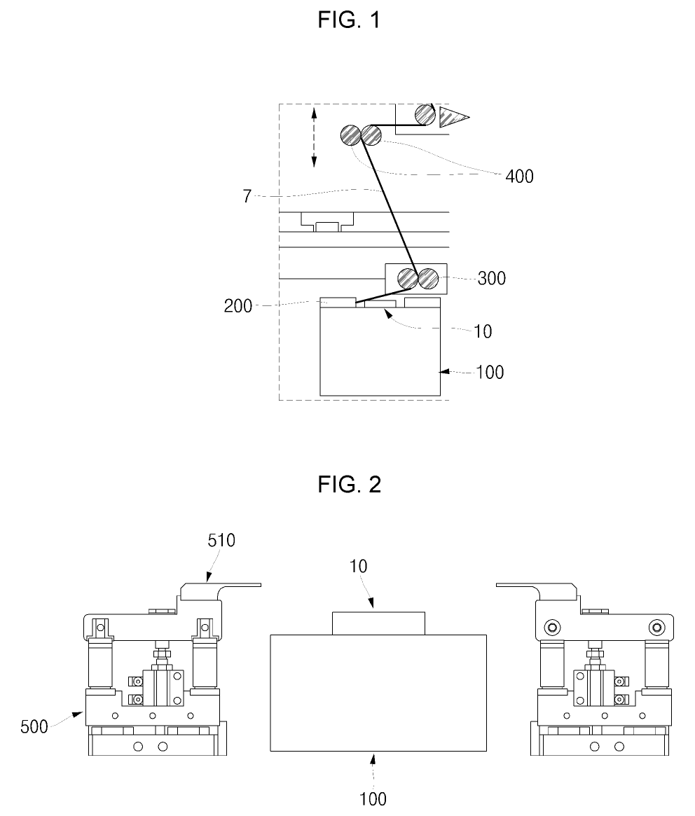

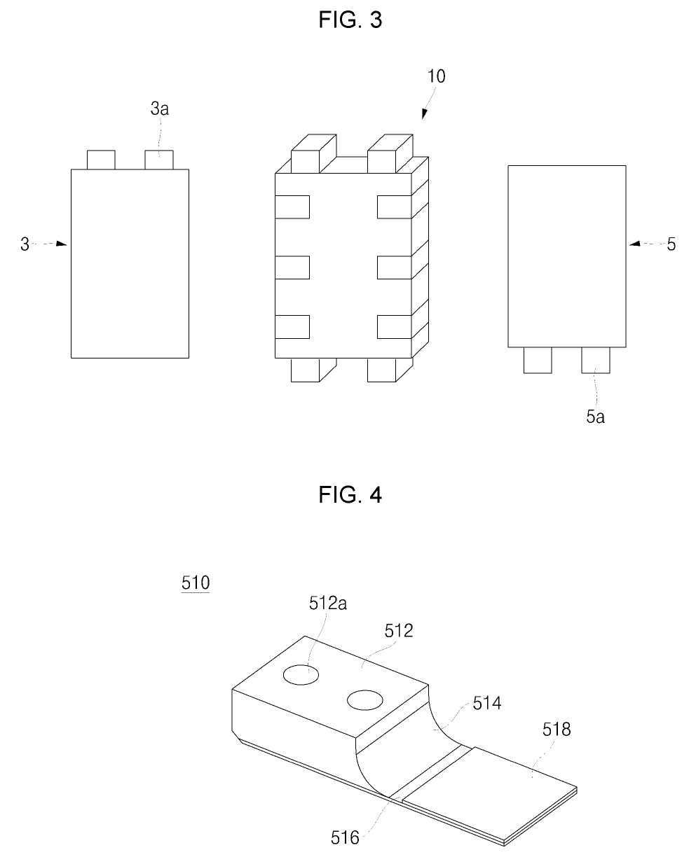

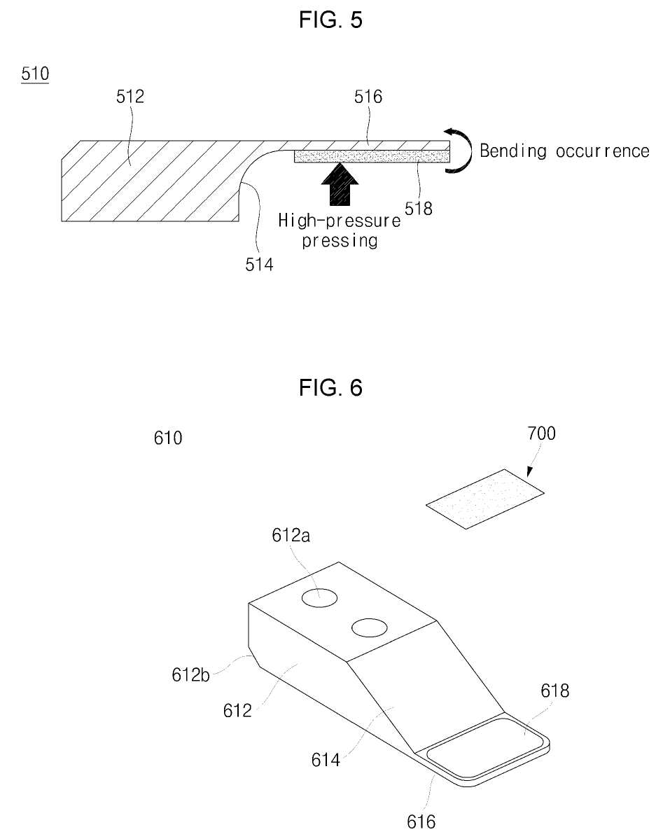

FIG. 1 is a schematic diagram showing a part of a manufacturing device for manufacturing a stack-type electrode assembly. FIG. 2 is a side view of a clamping device for clamping an electrode assembly stack. FIG. 3 shows an electrode assembly stack manufactured by the manufacturing device shown in FIGS. 1 and 2. FIG. 4 is a perspective view of a stack clamp of the clamping device shown in FIG. 2. FIG. 5 is a side view of the stack clamp shown in FIG. 4.

Referring to FIGS. 1-3, a manufacturing device for a stack-type electrode assembly 10 may include a stack table 100, an electrode plate supply device, a separator supply device, a stack clamping device 500.

The electrode plate supply device supplies individual negative electrode plates 3 and positive electrode plates 5 to the stack table 100. The separator supply device supplies a separator 7 to the stack table 100. The separator 7 may be an individual sheet, like the negative electrode plate 3 and positive electrode plate 5, or the separator 7 may be a roll-wound form. FIG. 1 shows parts of a device for making a stack-type electrode assembly 10 by supplying a separator 7 wound on a roll, folding the separator 7 in a zigzag manner, and inserting a negative electrode plate 3 and a positive electrode plate 5 between parts of the folded separators 7. The separator 7 is stacked in a zigzag-folded state by clamps 200 installed on both sides of the stack table 100. The separator 7 is while being maintained under tension by several rollers 300 and 400. The negative electrode plate 3 and the positive electrode plate 5 are each inserted between the folded separator 7. The negative electrode plate 3 and the positive electrode plate 5 may be stacked so that the negative electrode tab 3a and the positive electrode tab 5a face opposite directions (see FIG. 3). When the negative electrode plate 3 and the positive electrode plate 5 are stacked in this way, it is necessary to temporarily fix the negative electrode plate 3 and the positive electrode plate 5 so that they do not move. The stack clamping device 500 may be used be used to fix the plates 3 and 5.

Referring to FIG. 2, the stack clamping device 500 is installed a position spaced from the stack table 100, and a plurality of the stack clamping device may be provided. At least one stack clamp 510 is included with each stack clamping device 500. The stack clamp 510 temporarily fixes the electrode assembly 10 by applying pressure from above such that the electrode assembly 10 is maintained in a stacked state. When the stack clamp 510 presses the electrode assembly 10, it is desirable to not form pressing marks or damage on the negative electrode plate 3, positive electrode plate 5, and separator 7. Therefore, the stack clamp 510 is configured to not press the electrode assembly 10 with excessive pressure. Also, because the stack of the electrode assembly 10 is held in a gripped state, stack clamp should provide an appropriate gripping force. To this end, the stack clamp 510 has a thin tip 516 and a urethane pad 518 coated on the tip 516 (see FIG. 4).

Referring to FIGS. 4 and 5, the stack clamp 510 of the stack clamping device 500 includes a main body 512, a connecting portion 514, a tip 516, and a urethane pad 518. The main body 512 is provided with a hole 512a into which a fastening member, such as a bolt, for connection with the stack clamping device 500 is inserted. The main body 512 is a rectangular parallelepiped shape. The tip 516 is in a thin plate shape and is formed to be integrally connected to the main body 512 by the connecting portion 514. The connecting portion 514 is made round by grinding one end of the main body 512, and the thickness of the connecting portion 514 decreases in a direction moving away from the main body 512. The tip 516 is integrally extended from an end of the connecting portion 514, and the urethane pad 518 is coated on a surface of the tip 516. The urethane pad 518 is made of a urethane material, provides grip through friction, and acts as a cushion.

In general, the stack clamp 510 is manufactured through several complex processes. After W/C processing is performed by MCT-processing a SKD11heat-treated material, grinding is performed to create a rough shape, and then the final shape is created through finishing and high-speed processing. Then, the stack clamp 510 is completed through a plating process, coating process, final forming, and grinding process to coat the urethane pad 518. Since a urethane material does not adhere well to metal, sanding the surface of the tip 516 is an essential process to create an uneven shape to facilitate adherence of the urethane material. Thereafter, urethane is coated, hardened, and polished to a required shape to complete the stack clamp 510.

In the thus-manufactured stack clamp 510, the connecting portion 514 has a round value of approximately 5R. Here, 1R means a value corresponding to the circumference of a circle having a diameter of 1 mm. When the thickness of the main body 512 is 8.6 mm, the thickness of the tip 516 including the urethane pad 518 is only 1.58 mm (the thickness of the tip, excluding the urethane pad 518, is 1.4 mm). Since tip 516 is very thin, there is a problem of the tip 516 bending during a sanding work to coat the urethane pad 518. In addition, since the coating method of the urethane pad 518 is a high-pressure pressing method, the tip 516 may bend during the pressing. Therefore, the tip 516 should be straightened and corrected to coat a urethane material thereon, which complicates and lengthens the manufacturing process.

To solve these problems, a stack clamp with an improved structure is provided by the present disclosure.

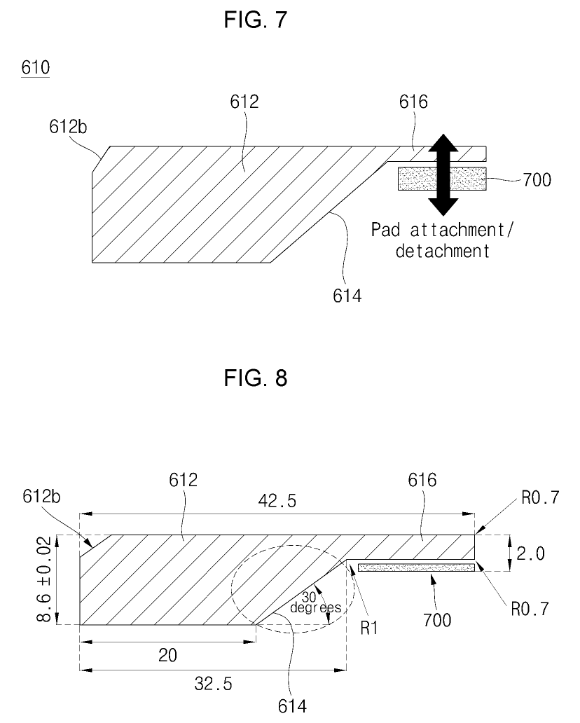

FIG. 6 is a perspective view of a stack clamp according to an embodiment of the present disclosure. FIG. 7 is a side view of the stack clamp shown in FIG. 6. FIG. 8 is a side view showing a detailed structure and size of the stack clamp shown in FIG. 6. Features that are the same as those above will be given.

Referring to FIGS. 6-8, a stack clamp 610 according to an embodiment of the present disclosure may include a main body 612, a connecting portion 614, a tip 616, a mounting surface 618, and a grip pad 700. The grip pad 700 may be mounted on the mounting surface 618. The main body 612, the connecting portion 614, the tip 616, and the mounting surface 618 may all be provided as one piece (e.g., integral to each other). Other than the grip pad 700, the stack clamp 610 may be made of steel.

The main body 612 may have a polyhedral shape and may be provided with the connecting portion 614 at one end. That is, one side in the longitudinal direction of the main body 612 may be inclined so as to create the connecting portion 614. The tip 616 may extend from an end of the connecting portion 614. The mounting surface 618 may be provided on one side of the tip 616. A section of the main body 612 excluding the tip 616 may have a cross-section that is trapezoidal as shown in FIG. 8 (not considering the shape of 612b). That is, as shown in FIG. 6, the upper and lower surfaces of the main body 612 may be parallel to each other, and one end surface of the main body 612 may be perpendicular to the upper and lower surfaces. In addition, the surface to the perpendicular surface becomes the connecting portion 614, and the connecting portion 614 may have an inclined surface shape. A through hole 612a may be provided between the upper and lower surfaces of the main body 612 on the basis of FIG. 6. The through hole 612a is for connecting the stack clamp 610 to the stack clamping device 500 (see FIG. 2) by using a bolt or the like. In addition, among edges of the main body 612, the edge facing the connecting portion 614 may be formed into the shape of an inclined surface.

As shown in FIG. 7, the direction of the main body 612 in which the tip 616 is disposed is an upward direction based on the direction when installed in the stack clamping device of FIG. 2. Accordingly, the mounting surface 618 may be provided on the lower surface of the tip 616. The lower surface of the main body 612 may have less area than the upper surface. The connecting portion 614 may be inclined from the lower surface of the main body 612 toward the upper surface. That is, as shown in FIG. 7, the connecting portion 614 may be shaped such that the length in the left and right direction of the main body 612 increases from the lower surface to the upper surface. The tip 616 may extend from the connecting portion 614 so as to be coplanar with the upper surface of the main body 612. The lower surface of the tip 616 may be made concave to provide a mounting surface 618. Since the grip pad 700 is attached to the mounting surface 618, the mounting surface 618 may be shaped to correspond to the shape of the grip pad 700. Further, the mounting surface 618 may be provided with a size and thickness corresponding to the size and thickness of the grip pad 700.

The grip pad 700 may be a rectangular shape. The grip pad 700 may have four corners processed to be streamlined in that the four corners are round shapes. And the mounting surface 618 may be formed in this shape. The grip pad 700 may need to clamp a 10-stack electrode assembly. Thus, the grip pad 700 may have enough thickness to protrude to outside of the mounting surface 618. That is, the thickness of the grip pad 700 may be greater than the depth of the mounting surface 618. In some examples, the grip pad 700 may be a sheet of a urethane material. The grip pad 700 may be attached to the mounting surface 618 by an adhesive tape. Thus, the grip pad 700 may be separated from the mounting surface 618. That is, the grip pad 700 may be provided in the form of a sheet that is detachably attached to the mounting surface 618. The stack clamp 610 according to embodiments the present disclosure may be constructed such that the mounting surface 618 is concave and the grip pad 700 is attached therein. In an experiment conducted under conditions where the surface pressure was increased by more than three times, it was confirmed that the stack clamp 610 could be used for more than 2.3 million times. That is, the lifespan of the stack clamp 610 can be maintained even if the grip pad 700 is attached without a complex coating structure.

The stack clamp 610 will now be described in more detail with reference to FIG. 8. In the following description, the term “length” means the length in the left-right direction of FIG. 8, and the term “height” means the length in the up-down direction.

In the depicted embodiment, the length of the upper portion from one end of the main body 612 to the other end of the tip 616 may be 42.5 mm. The length of the lower surface of the main body 612 may be 20 mm. The length from the lower surface of the main body 612 to the end (where the tip starts) of the connecting portion 614 may be 32.5 mm. Thus, the length from the starting point of the connecting portion 614 to the starting point of the tip 616 may be 12.5 mm. Accordingly, the length of the tip 616 may be 10 mm. The length from the upper surface to the lower surface of the main body 612 may be 8.6 mm (with a tolerance ±0.02 mm). One-end side of the main body 612, which is shown as left end side in FIG. 8,) may be a side that vertically connects the upper surface and the lower surface of the main body 612. The inclined surface 612b facing the connecting portion 614 may be provided on the upper side of the left side. The angle formed by the upper surface of the main body 612 and the inclined surface 612b may be the same as the angle formed by the lower surface of the main body 612 and the connecting portion 614. This angle may be, for example, 30 degrees. The height of the tip 616 may be 2 mm, including the protrusion of the grip pad 700. The R value of the area between the connecting portion 614 and the tip 616 may be 1R. The R value of the upper and lower edges at the end of the tip 616 may be 0.7.

As shown in FIG. 6, in some manufacturing processes the stack clamp 610 may be placed with the lower side facing upward, and then the mounting surface 618 may be processed. Thereafter, the grip pad 700 may be attached to the mounting surface 618, and the stack clamp 610 may be coupled to the stack clamping device 500 as shown in FIG. 7. Accordingly, the grip pad 700 may be placed toward the lower side of the stack clamp 610. The direction of the grip pad 700 is a direction in which the electrode assembly 10 may be pressed from above when the electrode assembly 10 is placed on the stack table 100 described above.

The stack clamp 610 according to the present disclosure is configured such that the thickness of the connecting portion 614 is more extended as compared to the stack clamp 510 shown in FIGS. 4 and 5. By removing and changing the shapes of unnecessary parts of the prior stack clamp 510, the strength of a region of the connecting portion 614, indicated by a dotted line in FIG. 8, is increased compared to existing shapes. Accordingly, the stack clamp 610 does not bend easily even when subjected to frequent impacts, the replacement cycle is extended, and the manufacturing cost can be reduced. In addition, the processing tolerance of the machine processing part when processing the stack clamp 610 was previously ±0.05, but is reduced to ±0.02 in embodiments of the present disclosure. As a result, the processing process can be simplified. In addition, by changing the coating method of a urethane pad to an attachment method, the processing process can be simplified and the manufacturing cost can be reduced.

While the foregoing embodiments have been provided for carrying out the present disclosure, it should be understood that the embodiments described herein are merely exemplary and the present disclosure is not limited to the expressly disclosed embodiments. Various changes in form and details may be made therein without departing from the spirit and scope of the disclosure.

What is claimed is:

1. A stack clamping device for stacking electrode assemblies, the stack clamping device comprising:
a main body having a polyhedral shape;
a connecting portion extending from an end of the main body;
a tip extending from an end of the connecting portion; and
a grip pad detachably attached to a surface of the tip.

2. The stack clamping device as claimed in claim 1, wherein the connecting portion is inclined relative to upper and lower surfaces of the stack clamping device.

3. The stack clamping device as claimed in claim 2, wherein the tip extends along a longitudinal direction of the main body.

4. The stack clamping device as claimed in claim 3, wherein the grip pad is attached to the surface of the tip so as to face an electrode assembly stack in a stacking process.

5. The stack clamping device as claimed in claim 4, wherein the stack clamp further comprises a concave mounting surface to which the grip pad is attached.

6. The stack clamping device as claimed in claim 5, wherein the grip pad is attached to the mounting surface by an adhesive or an adhesive tape.

7. The stack clamping device as claimed in claim 6, wherein the main body, the connecting portion, and the tip are provided as one body.

8. The stack clamping device as claimed in claim 7, wherein the main body, the connecting portion, and the tip are made of steel.

9. The stack clamping device as claimed in claim 8, wherein the grip pad is a sheet made of a urethane material.

10. The stack clamping device as claimed in claim 9, wherein the grip pad has a thickness that protrudes outwardly from the tip.

11. A stack clamping device for stacking electrode assemblies, the stack clamping device comprising:
a main body having a side that is trapezoidal shape;
a connecting portion extending from an end of the main body;
a tip extending from an end of the connecting portion; and
a grip pad detachably attached to a surface of the tip.

12. The stack clamping device as claimed in claim 11, wherein the main body comprises:
a connecting portion which is a side surface vertically connecting an upper surface and a lower surface that are parallel to each other; and
an inclined surface connecting the upper surface and the lower surface.

13. The stack clamping device as claimed in claim 12, wherein the tip extends from the connecting portion in a same plane as the upper surface of the main body.

14. The stack clamping device as claimed in claim 13, wherein the surface of the tip comprises a concave mounting surface .

15. The stack clamping device as claimed in claim 14, wherein the grip pad is attached to the mounting surface by an adhesive or an adhesive tape.

16. The stack clamping device as claimed in claim 15, wherein the grip pad is a sheet of made of a urethane material.

17. The stack clamping device as claimed in claim 16, wherein the grip pad has a thickness that protrudes outwardly from the tip.

18. The stack clamping device as claimed in claim 16, wherein, other than the grip pad, the stack clamping device is made of steel.
